(19) United States
(12) Patent Application Publication
(10) Pub. No.: US 2017/0024582 A1
(43) Pub. Date: Jan. 26, 2017

(54) SYSTEM AND METHOD FOR MEDIATING USER ACCESS TO GENOMIC DATA

(71) Applicant: DNASTACK CORP., Toronto (CA)

(72) Inventors: Marco Alessandro FIUME, Toronto (CA); James VLASBLOM, Toronto (CA); Ryan COOK, Toronto (CA); Miroslav CUPAK, Toronto (CA)

(21) Appl. No.: 15/080,534

(22) Filed: Mar. 24, 2016

Related U.S. Application Data
(60) Provisional application No. 62/138,125, filed on Mar. 25, 2015.

(51) Int. Cl. G06F 21/62; H04L 29/06

(52) U.S. Cl. CPC G06F 21/6245; G06F 21/6254; H04L 63/08

(57) ABSTRACT

Systems and methods are described for mediating user access to patient records and genomic data. At least one database is configured to store the genomic data. A server is in communication with the database. The server comprises storage, an authorization module and a function module. The storage stores at least one function defining a portion of the genomic data to be retrieved from the at least one database and the generation of a result set therefrom. The authorization module is configured to maintain function permissions for each of the at least one function. The function permissions define conditions under which the function can be invoked against a subset of the genomic data, restrictions on the portion of the genomic data defined by the function, and restrictions on the generation of the result set. The function module is configured to, during execution of the functions, restrict the portions of the genomic data retrieved from the at least one database, and restrict the result set generated therefrom in accordance with the function permissions.

### TECHNICAL FIELD

The following relates generally to database management systems and more specifically to systems and methods for mediating user access to genomic data.

### BACKGROUND

The complete or partial set of genomic variants an individual possesses can be of considerable value for research or clinical purposes. However, in many jurisdictions, and from an ethical standpoint, there may be privacy issues with the sharing of genomic data relating to identifiable persons.

### SUMMARY

In one aspect, a system for mediating user access to genomic data is provided, the genomic data comprising patient-identifiable information, the system comprising at least one database configured to store the genomic data, a server in communication with the database, the server comprising storage storing at least one function defining a portion of the genomic data to be retrieved from the at least one database and the generation of a result set therefrom, an authorization module configured to maintain function permissions for each of the at least one function, the function permissions defining conditions under which the function can be invoked against a subset of the genomic data, restrictions on the portion of the genomic data defined by the function, and restrictions on the generation of the result set, and a function module configured to, during execution of the functions, restrict the portions of the genomic data retrieved from the at least one database, and restrict the result set generated therefrom in accordance with the function permissions.

The subset of the genomic data can correspond at least partially to genomic data shared by an entity.

The function permissions can be granted by an administrator for the subset of the genomic data shared by the entity.

The subset of the genomic data can be undiscoverable by a user until the function permissions are granted to the user via an invitation from the administrator.

The function permissions can be granted to the user in response to a request from the user to access the genomic data shared by the entity.

The conditions can comprise the identity of a user.

The function permissions can comprise the subset of the genomic data.

One of the functions can specify that machine learning is used to during the generation of the result set.

A set of the function permissions can be associated with one or more of the subsets of the genomic data.

In another aspect, a method for mediating access user access to genomic data is provided, the genomic data comprising patient-identifiable information, the method comprising storing genomic data in at least one database, storing, in storage, at least one function defining a portion of the genomic data to be retrieved from the at least one database and the generation of a result set therefrom, maintaining function permissions for each of the at least one function, the function permissions defining conditions under which the function can be invoked against a subset of the genomic data, restrictions on the portion of the genomic data defined by the function, and restrictions on the generation of the result set, and restricting the portions of the genomic data retrieved from the at least one database and the result sets generated therefrom in accordance with the function permissions during the execution of the functions.

The subset of the genomic data can correspond at least partially to genomic data shared by an entity.

The method can further comprise granting, by an administrator, the function permissions of the subset of the genomic data shared by the entity.

The method can further comprise making the subset of the genomic data undiscoverable by a user until the function permissions are granted to the user via an invitation from the administrator.

The method can further comprise granting the function permissions to the user in response to a request from the user to access the genomic data shared by the entity.

The function permissions can comprise the identity of a user.

The function permissions can comprise the subset of the genomic data.

One of the functions can specify that machine learning is used to during the generation of the result set.

The method can further comprise associating a set of the function permissions with one or more of the subsets of the genomic data.

These and other aspects are contemplated and described herein. It will be appreciated that the foregoing summary sets out representative aspects of a system and method for mediating user access to genomic data to assist skilled readers in understanding the following detailed description.

### DESCRIPTION OF THE DRAWINGS

A greater understanding of the embodiments will be had with reference to the Figures, in which:

FIG. 1 is a schematic diagram of a system for mediating user access to genomic data and its operating environment;

FIG. 2 is a schematic diagram showing a number of physical components of the server system of FIG. 1;

FIG. 3 is a flow chart of the general method of registering a project with the system of FIG. 1;

FIG. 4 illustrates a method of mediating user access to genomic data in a research network; and

FIG. 5 illustrates a different operating configuration of the system 20 of FIG. 1.

### DETAILED DESCRIPTION

It will be appreciated that for simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

It will be appreciated that various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

It will be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

Genomic data, including the complete or partial set of genomic variants an individual possesses, can be of considerable value for research or clinical purposes, such as, for example, diagnosing disease, determining drug efficacies and side effects, and identifying genetic risk factors. It has been found that effective interpretation of genomic data may require querying and analyzing large sets of variants taken from a large population of individuals (referred to herein as “patients”, though it will be appreciated that the genomic data may originate from persons other than patients, such as genomic data donors from outside a hospital setting).

A system and method for mediating access to genomic data are provided herein. The system and method permit disparate users to share, access, query and analyze genomic data corresponding to multiple patients. The querying and analysis comprise the performance of queries across accessible patient records. In embodiments, the system and method permit disparate users to share and access genomic data, while restricting access to data such that the identity of specific patients whose genomic data resides within the system is obfuscated.

In embodiments, the system and method enable a user to share patient records, including genomic data, representing a project. The patient records may either be shared by providing access to a project database containing the patient records, or by adding the patient records to a central database. The system defines the user as the owner or administrator of the patient records shared by that user. Other users in the project (hereinafter, “project members”) can be provided with varying degrees of access to the patient records in the project. Patient records may include genomic data, sequence readings, genomic variants, comments on variant or patients, reports, basic patient information (including, for example, gender, name, etc.), and phenotypic presentations. Patient records typically comprise sensitive information capable of identifying patients. When used herein, “genomic data” may also include other data stored in the patient records that may be used to analyze the genomic data.

Where the patient records are stored centrally, the central database stores patient records for a plurality of projects, each having one or more project members. Project members respective to each project may view the patient records corresponding to the respective project.

Further, project members from disparate projects may collectively participate in a research network. Participants of the research network may be members of one project but non-members vis-à-vis other projects within the database. Participants of a research network are referred to herein as “network participants”. The system facilitates sharing and analysis of genomic data within a project with network participants via functions that are authorized by the administrators of each project. The functions can comprise queries and can also comprise other processing, such as statistical analysis, machine learning, or reporting. As will be understood, the result data for the functions can comprise subsets of patient records and/or processed results generated using subsets of the patient records. Direct access to the patient data is not provided by the functions unless they are so defined, thereby restricting access to sensitive aspects of patient records and controlling what patient data is exposed and how.

In further embodiments, a project administrator can elect to provide access to the genomic data for the project they manage via functions that they authorize for users who are neither project members nor network participants. Such users are referred to herein as “external users”.

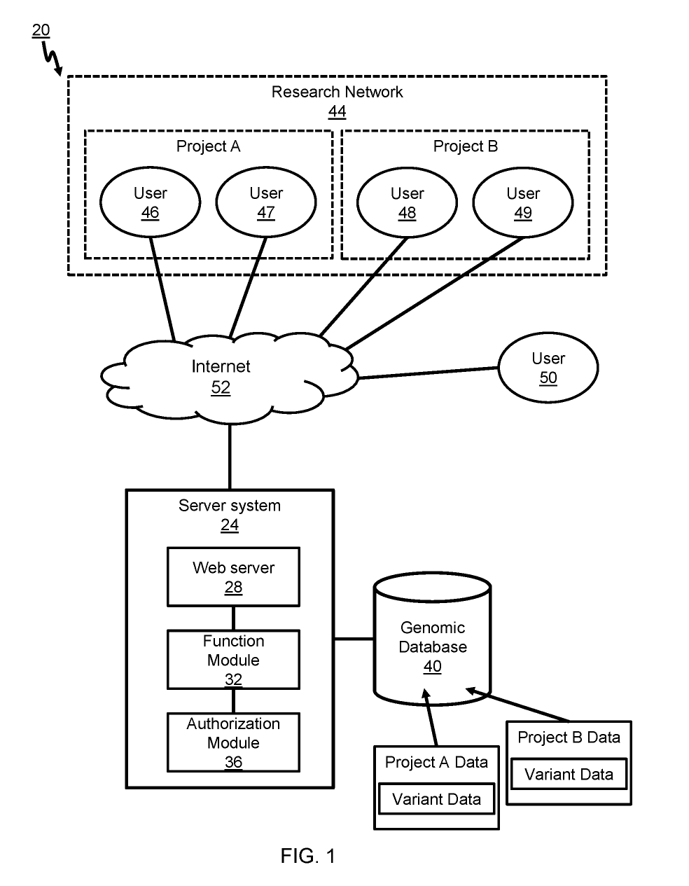

Referring now to FIG. 1, a system 20 for mediating user access to genomic data and its operating environment are shown. The system 20 comprises a server system 24. The server system 24 is a computer system having a number of software components, including a web server 28, a function module 32, and an authorization module 36. As will be appreciated, the server system 24 can a single physical computer or can be two or more computers acting cooperatively to provide the functionality described. The web server 28 provides a client interface by which client computing devices can connect to and interact with the server system 24. It will be appreciated that other types of client interfaces can be provided by the server system 24 to enable client computing devices, such as a custom application programming interface (“API”). Client computing devices can be any computing device that is operable to connect to and interact with the server system 24 via the client interface. The web server 28 can include, for example, a Java Enterprise Edition server component, and allow for data to be sent and received via a format such as, for example, JavaScript Object Notation (“JSON”). The web server 28 enables users to specify functions to be performed on genomic data. The function module 32 queries a genomic database 40, such as, for example, a standard SQL database, and can process genomic data retrieved from the genomic database 40 to perform the functions. As referred to herein, “database” comprises a set of genomic data stored in any suitable storage format. An authorization module manages a set of function permissions for each of the functions. The function permissions define conditions under which the function can be invoked against a subset of the genomic data, restrictions on the portion of the genomic data defined by the function, and restrictions on the generation of the result set. The function permissions can be modified via customizable parameters, described herein in greater detail. The authorization module maintains permissions, which may be enforced by considering user identities verified via an authentication protocol, such as, for example, OAuth2, to authenticate users. Therefore, the server system 20 may communicate with a third-party authorization server to obtain access tokens to identify a client computing device and/or its user.

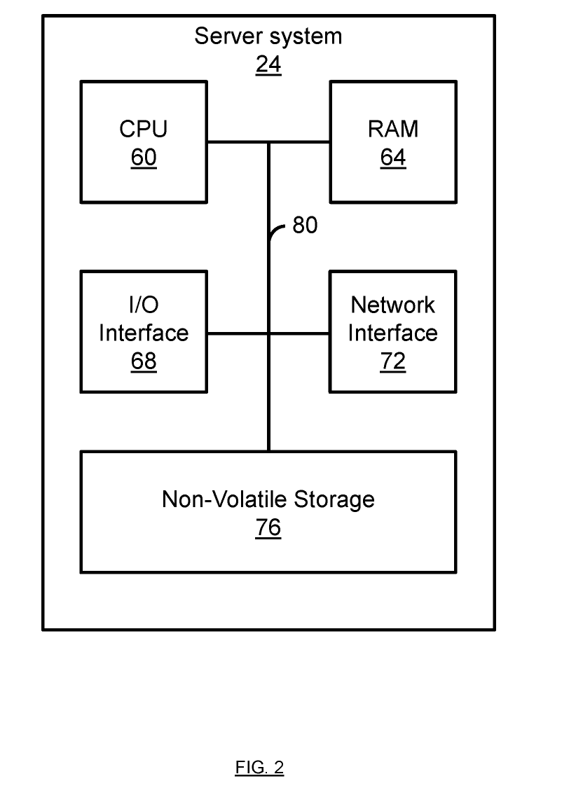

FIG. 2 shows various physical components of the server system 24 of FIG. 1. As shown, the server system 24 includes a central processing unit (“CPU”) 60, random access memory (“RAM”) 64, an input/output (“I/O”) interface 68, a network interface 72, non-volatile storage 76, and a local bus 80 enabling the CPU 60 to communicate with the other components. The CPU 60 executes an operating system, and various other components, including the web server 28, the function module 32, and the authorization module 36. RAM 64 provides relatively responsive volatile storage to CPU 60. The I/O interface 68 enables an administrator to interact with the server system 24 via a keyboard, a mouse, a speaker, and a display. The network interface 72 permits wired or wireless communication with other systems, such as client computing devices and one or more external genomic databases. Non-volatile storage 76 stores computer readable instructions for implementing the operating system, and the other components, including the web server 28, the function module 32, and the authorization module, as well as any data used by these modules, such as functions that can be performed and the permissions for these functions, and the genomic database 40. During operation of the server system 24, the operating system, the programs and the data may be retrieved from the non-volatile storage 76 and placed in RAM 64 to facilitate execution.

As previously described, the server system 24 enables parties to share groups of patient records and associated genomic data as projects. Projects shared form a research network. The server system 24 may oversee one or more research networks.

Referring back to FIG. 1, a research network 44 is shown as including a pair of projects, project A and project B. The projects represent sets of genomic data that are shared by entitles in the research network 44. The entities may be persons, organizations, companies, institutions, etc. Project A has two users 46 and 47 associated with it that interact with the server system 24 via respective client computing devices over the Internet 52. User 46 is deemed an administrator of project A as he has shared the patient records of project A with the server system 24 by uploading them to the server system 24. User 47 is a regular user of the server system 24 associated with project A and known to the administrator of project A, user 46. Similarly, project B has two users 48 and 49 associated with it that interact with the server system 24 via respective client computing devices over the Internet 52. User 48 is deemed an administrator of project B as he has shared the patient records of project B with the server system 24 by uploading them to the server system 24. User 49 is a regular user of the server system 24 associated with project B and known to the administrator of project B, user 48.

Further, user 50 is an external user; i.e., user 50 is not a member of either project A or B, nor a (research) network participant.

Users authenticate themselves to the server system 24 via any appropriate method, such as via login credentials provided via the web interface generated by the web server 28.

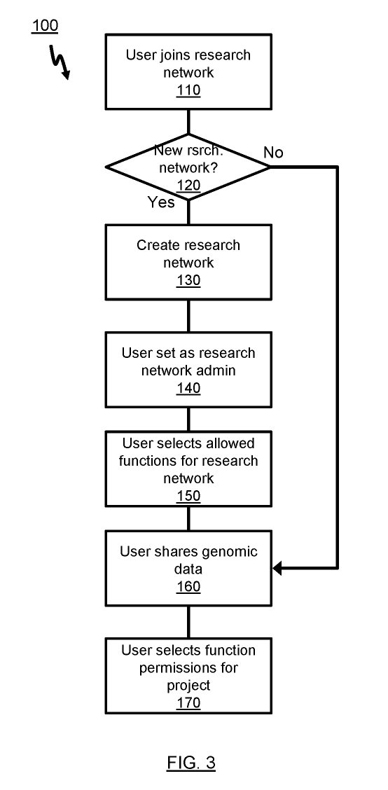

FIG. 3 shows the general method 100 of joining a research network. A user selects to join a research network (110). The user directs a web browser on his computing device to the server system 24 and selects to join an existing research network or to create a new research network via the web interface provided by the web server 28. If it is determined that the user has selected a new research network, the server system 24 creates a new research network (130). Upon creating the new research network, the server system 24 makes the user the research network administrator (140). The user creating a research network can control what kinds of functions are required to be allowed by participants in the research network (150). The server system 24 enables a research network administrator to define or modify a set of pre-defined functions for a research network. Functions can retrieve a portion of the genomic data across one or many projects and perform analysis on the retrieved genomic data to generate a result set. An example of a function is “find patients that have similar genetic markers (variant level, gene level, ontology level) and clinical features”.

Functions are designed to provide access to genomic data in a strictly controlled manner. The result set is defined such that the desired level of privacy for the genomic data is maintained. This is achieved through anonymization of the genomic data, aggregation of the data, or processing of the data in some other manner to obscure sensitive information in a desired manner. Functions are performed by the function module 32 and only the result set is shared with the user invoking the function. In this way, the interim data and calculations are rendered unavailable to the user unless explicitly permitted via the definition of the result set for a function.

A function can be defined to generate a result set from genomic data from two or more projects. Such functions are referred to as aggregate functions. The network administrator may select attributes and attribute values to search across more than one project, as well as an aggregation algorithm for processing the genomic data located with the query. As one user's permissions to invoke a particular function on the genomic data of each project can vary from those of another user, the invocation of the same function by two different users can yield differing result sets, even if performed simultaneously. For example, if user 46 has permission to invoke an aggregate function against the genomic data of both project A and project B, and user 49 only has permission to execute the same aggregate function against the genomic data of project B, then the result set of the aggregate function when invoked by user 46 may differ from the result set of the aggregate function when invoked by user 49.

The function module 32 may support common aggregation functions across projects in the database(s), such as, for example, average, sum, count, product, var (variance), std (standard deviation), min (minimum), max (maximum), median, and mode. Other functions could, of course, be defined.

Various types of functions can be invoked via the server system 24. For example:
matchmaking for rare diseases: find patients in a discovery network that have similar genetic markers (variant level, gene level, ontology level) and clinical features
matchmaking for donor matching: find patients in a discovery network who have compatible HLA profiles
genotype-phenotype associations: find the genetic markers that are most predictive of a clinical feature across patients in a discovery network
beacon search: find annotations associated with a specific genetic marker

### Aggregate Functions:

what is the allele frequency of a genetic marker across patients in a research network?
what is the average mutational load of patients with a clinical feature? patients with “normal” features?
what is the average coverage within a genomic window in a research network?

Upon the invocation of an aggregate function from a network member, the function module 32 may aggregate results across ontologies, patients, or genes. The aggregated results comprise a collection of tuples containing: a unique candidate key tuple; a set of one or more dependent aggregate values; and other attribute values. The result set for the aggregate function is designed in manner that the network member invoking the aggregate function cannot derive patient identities in a practical way.

Next, the user then shares genomic data (160). The user either uploads the genomic data being shared, or identifies its location. The location of the genomic data can be the network address from which the genomic data can be retrieved by the server system 24 for storing in the database 40, or alternatively can be the address of a database that stores the genomic data being shared. The database 40 structures the genomic data from the patient records according to attributes, as previously described. The server system 24 can mediate user access to genomic data that is stored by the server system 24 or is made accessible to the server system 24 Credentials may be provided to the server system 24 to enable its accessing of genomic data stored in other databases. Upon sharing the genomic data, the user selects permissions for users or groups of users to invoke the functions on the shared data (170). The functions for which permissions can be defined are those specified during 150 at research network creation. A function permission can define the ability to invoke a function of a particular type against the genomic data in a project. Each function is mapped to a set of attribute permissions. Attribute permissions are arbitrary rules on data visibility. For example, patient attributes like name and address may be excluded while genomic attributes like variation details may be included.

The project administrator can invite other people to join the project. In the scenario illustrated in FIG. 1, user 46 may have created the research network and is deemed the project administrator. User 46 can then invite user 47 to join project A and may therefore participate in the research network.

The authorization module 36 is configured to enable the definition and enforcement of permissions for the functions that are established for the research network. One or more rules can be provided by a project administrator for specifying the conditions under which a particular function is permitted on a particular subset of the genomic data of the project. The conditions can specify whether a function can be invoked, restrictions on data visibility to the function, and restrictions on the output of a function. The user selects the parameters using the web interface presented on his or her computing device. Groups of users can include, for example, users in the research network (hereinafter, “network members”), users of a particular project, project administrators, and users outside of the research network (such as user 50).

For example, as shown, projects A and B are enrolled in the research network. Once project B is enrolled in the research network, its members, users 48 and 49, may be able to invoke certain functions against project A's genomic data as network members that they could not invoke prior to enrolling in the research network.

The authorization module is configured to enable a research network administrator to invite additional users or projects to join the research network.

The following table provides an example of a plurality of possible functions, along with result sets that could be provided to a network member invoking the functions. The illustrated functions are: (1) find the frequency of particular variants in a population; (2) find the frequency of variants within a particular gene, for a particular individual (e.g., patient X has 5 variants in the gene MCFD2; mutations in MCFD2 have been reported to be associated with a bleeding disorder); (3) find the number of variants there are in this population within the gene MCFD2; (4) find the frequency of individuals that have a mutation within a transmembrane domain of MCFD2 (5) find the frequency of individuals that have a mutation linked to the HPO term ‘diabetes’?; (6) show the variant frequency distribution across (anonymized) patients.

| # | Candidate Key | Aggregate | Attribute |
|---|---|---|---|
| 1 | (chrom, pos, ref, alt) | variant freq across | Diseases associated with |
| | | individuals | this variant. |
| 2 | (gene, individual) | # of variants per | Diseases associated with |
| | | gene, for each | gene defects. |
| | | individual | |
| 3 | (gene id) | variant count | gene name |
| | | within gene | |
| 4 | (gene id, domain) | domain variant | domains predicted to |
| | | freq across | interact with the domain |
| | | individuals, | the candidate key. |
| 5 | HPO disease id | variant freq | HPO disease description |
| 6 | individual | variant freq | — |

The following table provides an example of a source data table of genomic data.

| Chrom | Position | Ref | Alt | Gene ID | Gene Name | Domain | Patient ID | Patient Name |
|---|---|---|---|---|---|---|---|---|
| 1 | 32 | A | G | 23 | LMAN1 | TMH | 456 | J. Doe |
| 1 | 32 | A | G | 23 | LMAN1 | TMH | 327 | M. Smith |
| 1 | 32 | A | G | 23 | LMAN1 | TMH | 727 | J. Doe |
| 1 | 47 | G | C | 23 | LMAN1 | — | 727 | J. Doe |
| 7 | 390 | A | T | 47 | PARK7 | — | 456 | J. Doe |
| 7 | 390 | A | T | 47 | PARK7 | — | 873 | K. Jones |
| 7 | 450 | A | G | — | — | — | 987 | B. Jackson |

The following table provides an example of a plurality of possible result sets provided to a network member in response to function (3) above using the above source data.

| | | | | | | | | | |
|---|---|---|---|---|---|---|---|---|---|
| | | | | | | | | | Count |
| | | | | | | | | | (distinct |
| | | | | | | | | | chrom, |
| | | | | Gene | Gene | | Patient | Patient | position, |
| Chrom | Position | Ref | Alt | ID | Name** | Domain* | ID | Name | ref, alt) |

| | | | |
|---|---|---|---|
| 23 | LMAN1 | Indeterminate | 2 |
| 47 | PARK7 | Indeterminate | 2 |

This function has been defined such that the following data items have been excluded from the result set: “Chrom”, “Position”, “Ref”, “Alt”, “Patient ID”, and “Patient Name”. The data item “Gene ID” is included in the result set as it has been used by the function module as a candidate key. The data item “Gene Name” is in the query results obtained by the function module 32 but is not included in the candidate key. The data item “Domain” is in the query results obtained by the function module 32 retrieved from the database 40 but not included in the candidate key nor returned in the result set to the network member. The column “count” includes the query result.

The function module 32 may return to the network member an output including the following data:

| Gene ID | Gene Name | count (distinct chrom, position, ref, alt) |
|---|---|---|
| 23 | LMAN1 | 2 |
| 47 | PARK7 | 2 |

The following table provides an example of a plurality of possible query results obtained by the function module 32 from the database 40, as well as corresponding result set provided to a user in response to function (4) above using the foregoing source data.

| | | | | | | | | | |
|---|---|---|---|---|---|---|---|---|---|
| | | | | Gene | Gene | | Patient | Patient | Count (distinct |
| Chrom | Position | Ref | Alt | ID | Name | Domain | ID | Name | patient id) |

| | | | |
|---|---|---|---|
| 23 | LMAN1 | TMH | 3 (of 5 distinct |
| | | | patients) |
| 23 | LMAN1 | — | 1 (of 5 distinct |
| | | | patients) |
| 47 | PARK7 | — | 2 (of 5 distinct |
| | | | patients) |

The data items “Chrom”, “Position”, “Ref”, “Alt”, “Patient ID”, and “Patient Name” have all been defined as inaccessible attributes by permissions. The data items “Gene ID” and “Domain” are allowed by the permissions and have been used by the function module as a candidate key. The column “Gene Name” is an allowed attribute by the role and is returned to the network member in the query result but is not included in the candidate key. The column “count” includes an additional computed result of the function.

The function module may return to the network member an output including the following data:

| Gene ID | Gene Name | Domain | Freq |
|---|---|---|---|
| 23 | LMAN1 | TMH | 0.60 |
| 23 | LMAN1 | — | 0.20 |
| 47 | PARK7 | — | 1.00 |

The following table provides an example of a plurality of possible query results as well as corresponding output to a network member in response to query (6) using the foregoing source data.

| | | | | | Gene | | Patient | Patient | Count (distinct |
|---|---|---|---|---|---|---|---|---|---|
| Chrom | Position | Ref | Alt | Gene ID | Name | Domain* | ID | Name | patientId) |
| 1 | 32 | A | G | indeterminate | indeterminate | indeterminate | indeterminate | indeterminate | 3 (of 5 distinct |
| | | | | | | | | | patients) |
| 1 | 47 | G | C | indeterminate | indeterminate | indeterminate | indeterminate | indeterminate | 1 (of 5 distinct |
| | | | | | | | | | patients) |
| 7 | 390 | A | T | indeterminate | indeterminate | indeterminate | indeterminate | indeterminate | 2 (of 5 distinct |
| | | | | | | | | | patients) |
| 7 | 450 | A | G | indeterminate | indeterminate | indeterminate | indeterminate | indeterminate | 1 (of 5 distinct |
| | | | | | | | | | patients) |

In this example, no columns have been defined as inaccessible attributes by the permissions, however the columns the columns “Gene ID”, “Gene Name”, “Domain”, “Patient ID” and “Patient Name” are not returned to the network member. The columns “Chrom”, “Position”, “Ref”, and “Alt” are visible attributes and have been used by the function module as the candidate key. The column “count” includes the query result.

The function module may return to the network member an output including the following data:

| Chrom | Position | Ref | Alt | Freq |
|---|---|---|---|---|
| 1 | 32 | A | G | 0.60 |
| 1 | 47 | G | C | 0.20 |
| 7 | 390 | A | T | 0.40 |
| 7 | 450 | A | G | 0.20 |

For genes and ontology terms, a minimal candidate key may be a numeric identifier. The association between the numerical candidate key details about the gene or ontology term, such as, for example, names and descriptions, may be indicated to the requesting user via the user interface.

For patients, the minimal candidate key serves to distinguish results between individuals. The candidate key is anonymous: while it serves as a unique identifier for genomic data within a patient record, it is not practical to interpret it as an identifier of the patient. The patient candidate key is mapped to patient records, but the research network authorization module does not permit network participants to view the mapping. Preferably, the authorization module 36 also restricts access to the mapping of the patient candidate key to patient records in the database so that no user may unambiguously correlate the aggregate results to their respective patient data on the database 40.

The candidate key may include other attributes in addition to the minimal identifier, to allow for more flexible aggregation. In other words, aggregation could be performed by including one attribute in the candidate key, two attributes in the candidate key, etc.

Result sets are computed on the set of variant tuples across all accessible projects enrolled in the research network (accessible meaning the attribute and invocation permissions for a project are sufficiently permissive for the function). Thus, users invoking functions benefit from large scale data. The function module 32 applies an aggregation algorithm across all variant tuples having the same candidate key. Attribute values are selectable by the user invoking the function via the web interface presented in the web browser on the user's computing device, and may include ancillary information of interest, such as gene names or ontology term names, limited by the data that is allowed by the permissions of the user invoking the function.

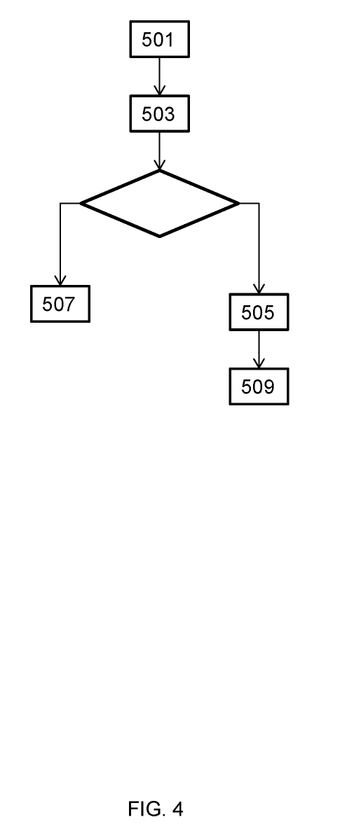

Referring now to FIGS. 2 and 4, the general method used by the server system 24 is illustrated for mediating network participant access to genomic data in the database. At block 501, a network member 48 selects a function to invoke through the user interface presented on the client computing device of the network participant. At block 503, the function module 32 identifies projects for which the user is assigned permissions to invoke the function, and includes genomic data from those projects in the analysis at block 505. At block 507, the function module 32 ignores data from projects for which the network member lacks permission to invoke the selected function. At block 509, the server system 32 returns the result set defined for the invoked function generated using the genomic data from the projects identified at 503 to the network member 48.

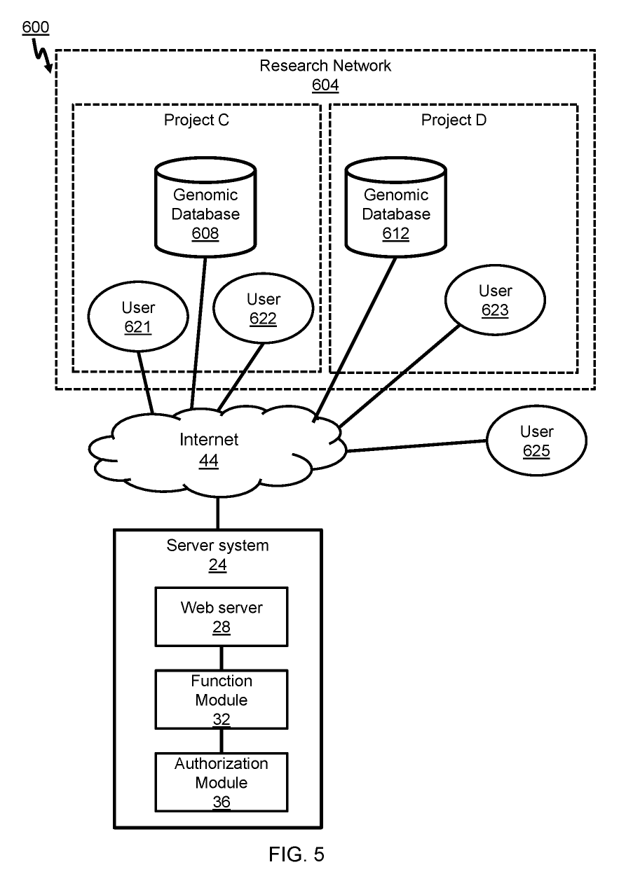

FIG. 5 shows the server system 24 of FIG. 1 in a different configuration. In this configuration, the project patent data is maintained external to the server system 24. A research network 604 is shown having two projects, project C and project D. Project C maintains a genomic database 608 for its patient data, and has two users registered with the server system 24, user 621 and user 622. Project D also maintains a genomic database 612, and has one user registered with the server system 24, user 623. Genomic databases 608 and 612 are accessible to the server system 24 such that the function module 32 can run queries against the data contained by them. The function module 32 may be provided with any transformation rules for transforming the genomic data contained by the genomic databases 608, 612 into a form that us understood by the function module 32.

The server system 24 can be configured to execute an aggregate function against a first project's genomic data stored in a local database and a second project's genomic data stored in a remote database, and provide an aggregate result set. The local database maintained by the server system may be maintained within the storage of the server system or accessed on a database server.

In embodiments, the functions can be performed on demand. In other embodiments, the server system may queue the invocation of functions and process them in accordance with the queue. In further embodiments, the server system may queue the execution of functions and process them in accordance with a scheduling technique. For example, functions can be specified to run repeatedly, such as, for example, once a night, week, or month.

While the system provides mediated access to stored human genomic data in the above-described embodiments, it will be appreciated that the system can be used with non-human genomic data.

While the system described in the embodiments above retrieve genomic data from a database via querying, it will be appreciated that the genomic data can be stored in data sources of other types and in other formats, and the system can retrieve the data in an appropriate manner based on the format. For example, the genomic data may be stored as a text file that the server system parses to locate a subset of the genomic data of interest.

Although the foregoing has been described with reference to certain specific embodiments, various modifications thereto will be apparent to those skilled in the art without departing from the spirit and scope of the invention as outlined in the appended claims. The entire disclosures of all references recited above are incorporated herein by reference.

1. A system for mediating user access to genomic data, the genomic data comprising patient-identifiable information, the system comprising:
at least one database configured to store the genomic data;
a server in communication with the database, the server comprising:
storage storing at least one function defining a portion of the genomic data to be retrieved from the at least one database and the generation of a result set therefrom;
an authorization module configured to maintain function permissions for each of the at least one function, the function permissions defining conditions under which the function can be invoked against a subset of the genomic data, restrictions on the portion of the genomic data defined by the function, and restrictions on the generation of the result set; and
a function module configured to, during execution of the functions, restrict the portions of the genomic data retrieved from the at least one database, and restrict the result sets generated therefrom in accordance with the function permissions.

2. The system of claim 1, wherein the subset of the genomic data corresponds at least partially to the genomic data shared by an entity.

3. The system of claim 2, wherein the function permissions are granted by an administrator for the subset of the genomic data shared by the entity.

4. The system of claim 3, wherein the subset of the genomic data is undiscoverable by a user via the system until the function permissions are granted to the user via an invitation from the administrator.

5. The system of claim 3, wherein the function permissions are granted to the user in response to a request from the user to access the genomic data shared by the entity.

6. The system of claim 1, wherein the conditions comprise the identity of a user.

7. The system of claim 1, wherein the conditions comprise the subset of the genomic data.

8. The system of claim 1, wherein one of the functions specifies that machine learning is used to during the generation of the result set.

9. The system of claim 1, wherein a set of the function permissions is associated with one or more of the subsets of the genomic data.

10. A method for mediating access user access to genomic data, the genomic data comprising patient-identifiable information, the method comprising:
storing the genomic data in at least one database;
storing, in storage, at least one function defining a portion of the genomic data to be retrieved from the at least one database and the generation of a result set therefrom;
maintaining function permissions for each of the at least one function, the function permissions defining conditions under which the function can be invoked against a subset of the genomic data, restrictions on the portion of the genomic data defined by the function, and restrictions on the generation of the result set; and
restricting the portions of the genomic data retrieved from the at least one database and the result sets generated therefrom in accordance with the function permissions during the execution of the functions.

11. The method of claim 10, wherein the subset of the genomic data corresponds at least partially to the genomic data shared by an entity.

12. The method of claim 10, further comprising:
granting, by an administrator, the function permissions for the subset of the genomic data shared by the entity.

13. The method of claim 12, further comprising:
making the subset of the genomic data undiscoverable by a user via the system until the function permissions are granted to the user via an invitation from the administrator.

14. The method of claim 12, further comprising:
granting the function permissions to the user in response to a request from the user to access the genomic data shared by the entity.

15. The method of claim 10, wherein the function permissions comprise the identity of a user.

16. The method of claim 11, wherein the function permissions comprise the subset of the genomic data.

17. The method of claim 10, wherein one of the functions specifies that machine learning is used to during the generation of the result set.

18. The method of claim 10, further comprising associating a set of the function permissions with one or more of the subsets of the genomic data.
